(19) United States
(12) Patent Application Publication
(10) Pub. No.: US 2012/0000432 A1
(43) Pub. Date: Jan. 5, 2012

(54) BEHAVIOR-CORRECTING ANIMAL LEASH

(76) Inventor: Patrick Michael Guiant, San Diego, CA (US)

(21) Appl. No.: 13/158,360

(22) Filed: Jun. 10, 2011

Related U.S. Application Data
(60) Provisional application No. 61/360,806, filed on Jul. 1, 2010.

(51) Int. Cl. A01K 27/00

(52) U.S. Cl. 119/792

(57) ABSTRACT

An adjustable animal harness designed to apply pressure to an animal's body and tug at its collar when it pulls against its leash, inducing the animal to exhibit good behavior when being walked. The harness attaches to an animal collar via an adjustable strap designed to accommodate animals of different sizes. The adjustable strap has a ring on one end to which a second strap is also attached. The second strap wraps around the body of the animal and is passed through the ring. On the other end of the second strap is a smaller ring which can pass through the larger ring. When wrapped around the body of an animal and passed through the larger ring, a leash can attach to the second strap via the smaller ring. The harness tightens around an animal's body and tugs at its collar when the animal pulls against the leash. As the animal pulls against the leash with more exertion, the harness becomes tighter around its body and more resistance is applied to its collar.

### CROSS-REFERENCE TO RELATED APPLICATIONS

This application claims priority under 35 U.S.C. Section 119(e) to provisional application 61/360,806, filed on Jul. 1, 2010, which application is hereby incorporated by reference in its entirety.

### BACKGROUND OF THE INVENTION

Various forms of leashes and harnesses for animals are known. However, animals tend to pull against these devices, causing discomfort and difficulty when walking the animal.

### SUMMARY OF THE INVENTION

In one embodiment, an animal leash comprises first and second straps joined by a coupler, a first strap of which is configured at its opposite end for attaching to a leash.

In another embodiment, an animal leash comprises a collar connector and means for threading an end of the leash through an internal portion of the leash.

In another embodiment, a method of harnessing an animal for walking the animal comprises securing a first portion of at least one strap to a collar of the animal, wrapping the at least one strap around the body of the animal, and threading an end of the at least one strap through an internal portion of the at least one strap.

In another embodiment, an animal leash comprises at least one strap and an opening positioned at an internal portion of the at least one strap. The internal portion corresponds to a position on an animal's back between the chest and hind legs, and an end of the at least one strap is threaded through the opening.

In another embodiment, a leash portion comprises a strap sized to fit along only a portion of an animals back. The strap has a collar connector at one end and a connector for another strap at the other end.

### BRIEF DESCRIPTION OF THE DRAWINGS

FIG. 1 illustrates an animal leash according to one embodiment.

FIG. 2 illustrates the animal leash of FIG. 1 on an animal.

### DETAILED DESCRIPTION OF THE PREFERRED EMBODIMENT

The invention relates to animal control harnesses and, more particularly, to an animal control harness of simple design with which an animal is easily outfitted and which safely provides resistance to an animal straining against a leash.

This device is a harness designed for use with dogs and other four-legged animals. The device provides restriction on the body of the animal if the animal pulls away from the person attending to the animal with a leash. The extent to which the harness tightens around the animal depends on the amount of force with which the animal pulls away from its leash. The harness may optionally be adjustable to appropriately fit the body of several different size animals.

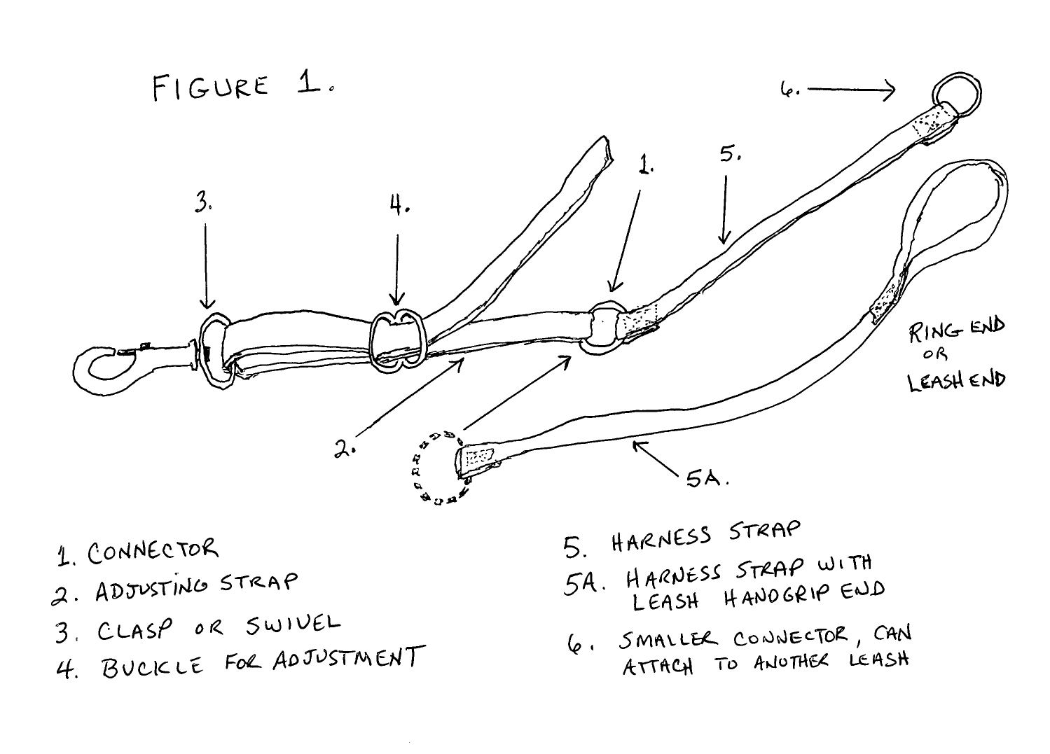

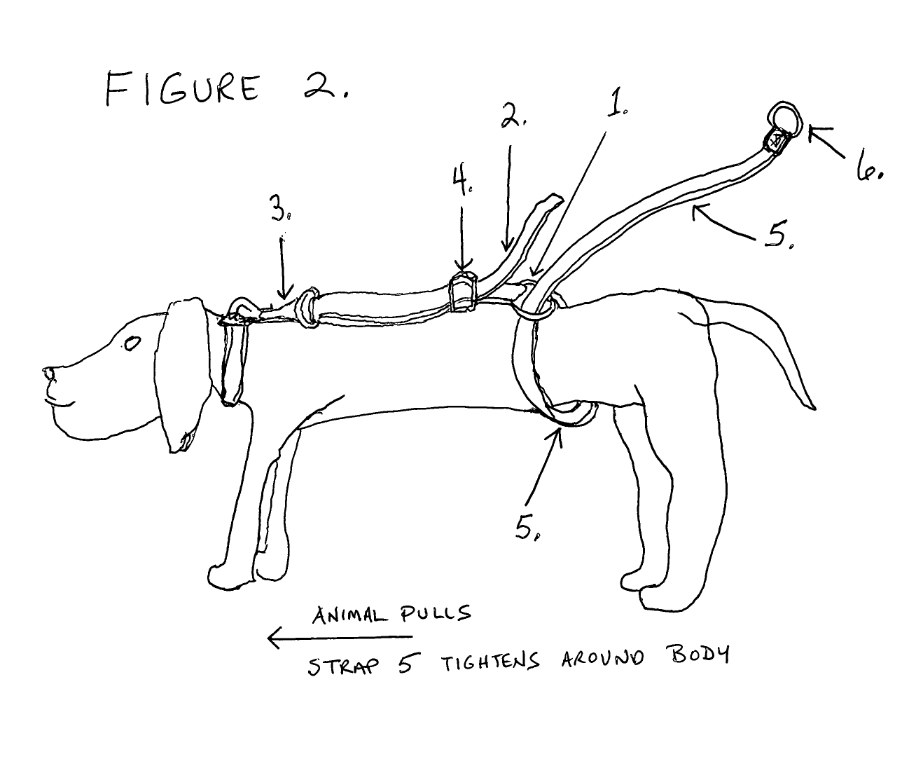

Referring to FIGS. 1 and 2, the invention comprises at least a first strap 2. One end of this strap attaches to the animal's collar. The other end of this strap may attach to a connector 1 made of metal or some other sturdy material. This strap 2 can be designed to be lengthened or shortened to span a portion of the length of the animal's back depending on the size of the animal. This strap is typically arranged to extend from the animal's collar to the place on its back that is between the animal's chest and hind legs.

When the harness is applied to an animal, the connector attached to this strap rests upon the animal's back. This connector may also attach to another strap 5. This second strap wraps around the torso of the animal, traveling from the connector situated on the animal's back down one side of the animal, across its stomach, and up the other side of the animal. At this point, the second strap reaches the connector situated on the animal's back. The second strap passes through the connector, encompassing the animal with the strap.

Another connector 6 may be provided at the other end of the second strap. This connector is small enough that it is able to pass through the connector 1 on the animal's back. When the second strap is wrapped around the animal's torso and passed through the connector, the connector attached to other end of the second strap is available to attach to a leash. Alternatively, this end of the second strap 5 may comprise a standard looped leash end and be directly held by the user when walking the animal.

While the animal is being walked, if it pulls away from the leash, it causes tension in the second strap. This tension is uncomfortable to the animal and thus dissuades the animal from engaging in this behavior. At the same time, the tightening of the strap and the tugging of the collar do not harm the animal. The animal is not choked when it pulls away from the leash because the pulling does not affect the circumference of the collar. Additionally, an upward force is exerted on the back end of the animal when the animal pulls against the leash and causes the strap to tighten. This lifts the back end of the animal and reduces the amount of traction the animal can obtain with its rear legs, making the animal easier to handle as it struggles against the leash and discouraging the animal from partaking in this behavior.

Other advantages of this invention include its simplicity, the ease and low cost of manufacturing, and the ease and speed with which it can be applied to the animal.

It will be appreciated that a wide variety of connector 1 designs can be used. Although a ring has been found very suitable because it is very easy to thread the second strap 5 through during attachment, it need not take this form. Any device with an opening that is positioned at an internal portion of the leash may be utilized. In some such embodiments, a single continuous strap is used. It is also possible to not use a separate element or device as the connector. For example, a slit or other hole at an internal portion of a continuous strap may be provided for threading the other end of the strap through after wrapping around the animal's body.

It will further be appreciated that the first strap 2 and second strap 5 could be sold separately, with the second strap coupled to the connector by a user. The second strap 5 could be a standard leash, for example, hooked to the ring 1 with its collar clasp. It could then be wrapped around the animal as described above.

What is claimed is:

1. An animal leash comprising first and second straps joined by a coupler, a first strap of which is configured at its opposite end for attaching to a leash.

2. The animal leash of claim 1, wherein a second strap is configured for attachment to a collar.

3. The device in claim 1 wherein the length of the strap which is not capable of attaching to a leash can be adjusted.

4. An animal leash comprising:
a collar connector; and
means for threading an end of the leash through an internal portion of the leash.

5. A method of harnessing an animal for walking the animal, the method comprising:
securing a first portion of at least one strap to a collar of the animal;
wrapping the at least one strap around the body of the animal; and
threading an end of the at least one strap through an internal portion of the at least one strap.

6. The method of claim 5, comprising placing the internal portion on the back of the animal.

7. The method of claim 5, comprising wrapping the at least one strap around the body of the animal at a position between the chest and hind legs of the animal.

8. An animal leash comprising:
at least one strap;
an opening positioned at an internal portion of the at least one strap, the internal portion corresponding to a position on an animal's back between the chest and hind legs;
wherein an end of said at least one strap is threaded through said opening.

9. The leash of claim 8, wherein the opening is provided in a separate part.

10. The leash of claim 8, wherein the opening is part of the at least one strap.

11. A leash portion comprising a strap sized to fit along only a portion of an animals back, said strap having a collar connector at one end and a connector for another strap at the other end.
